(19) United States
(12) Patent Application Publication
(10) Pub. No.: US 2025/0343234 A1
(43) Pub. Date: Nov. 6, 2025

(54) NEGATIVE ELECTRODE ACTIVE MATERIAL, LITHIUM SECONDARY BATTERY CONTAINING THE SAME, AND METHOD OF MANUFACTURING NEGATIVE ELECTRODE ACTIVE MATERIAL

(71) Applicant: EBS SQUARE, Inc., Seongnam-si (KR)

(72) Inventors: Sungwon HWANG, Hwaseong-si (KR); Kwan Sun PARK, Suwon-si (KR)

(73) Assignee: EBS SQUARE, Inc., Seongnam-si (KR)

(21) Appl. No.: 18/882,976

(22) Filed: Sep. 12, 2024

(30) Foreign Application Priority Data
May 3, 2024 (KR) 10-2024-0059439

(51) Int. Cl. H01M 4/58; C01B 33/113; H01M 4/02; H01M 4/04; H01M 4/583; H01M 4/62; H01M 10/0525

(52) U.S. Cl. CPC H01M 4/5825; C01B 33/113; H01M 4/0471; H01M 4/583; H01M 4/625; H01M 10/0525; H01M 2004/027

(57) ABSTRACT

There is provided a negative electrode active material containing: a silicon-based active material; a carbon-based active material; a carbon nanoparticle; and a graphene quantum dot (GQD).

### CROSS-REFERENCE TO RELATED APPLICATION(S)

This application claims benefit of priority to Korean Patent Application No. 10-2024-0059439 filed on May 3, 2024 in the Korean Intellectual Property Office, the disclosure of which is incorporated herein by reference in its entirety.

### BACKGROUND

### 1. Field

The present disclosure relates to a negative electrode active material having improved electric capacity, initial efficiency, and rate characteristics, a lithium secondary battery containing the same, and a method of manufacturing the negative electrode active material.

### 2. Description of Related Art

Recently, an electric vehicle market has been expected to grow about 40 times or more by 2030. Existing lithium secondary batteries have a limited energy density of 810 Wh/l, but next-generation lithium secondary batteries require an energy density of 1,000 Wh/l or more, and therefore, the need to increase the capacity of the batteries has emerged. The growth of the electric vehicle market continuously increases the demand for the lithium secondary batteries, and the lithium secondary batteries have been widely used due to advantages such as a high energy density, a long cycle lifespan, and high stability. However, the existing lithium secondary batteries mainly use a graphite negative electrode material with a low capacity (374 mAh/g), and it is thus difficult to meet requirements of a high energy density for batteries for electric vehicles. In order to meet the market demand for secondary batteries with a high energy density, research into materials and structures that improve the energy density of the lithium secondary batteries has been actively conducted.

Silicon oxide (SiOₓ) has been mainly studied as a negative electrode material for improving the energy density of the lithium secondary batteries. Silicon oxide has a higher capacity than a carbon material and has superior cycle stability and initial power efficiency than silicon (Si). However, silicon oxide has a disadvantage such as low electrical conductivity, and causes continuous formation and change of a solid electrolyte interphase (SEI) layer at an interface with an electrolyte due to volume expansion during charging and discharging to cause low initial efficiency and a rapid decrease in capacity.

Silicon oxide reacts with an electrolyte in an initial lithiation process to form lithium oxide (Li₂O) and lithium silicate (LiₓSiO_{y}). For this reason, silicon oxide buffers a large volume change, resulting in improved cycle performance. Nevertheless, the formed lithium oxide and lithium silicate have a disadvantage of consuming lithium ions through an irreversible reaction and causing volume expansion of silicon oxide. For this reason, a structure becomes unstable and an uneven SEI layer is formed, such that electrochemical performance deteriorates.

In order to solve the aforementioned problems, research into a technology that forms a silicon oxide/carbon composite by mixing a carbon material having high electrical conductivity and a crystal structure has been conducted.

### SUMMARY

An embodiment of the present disclosure is to provide a negative electrode active material having improved electrical conductivity and structural stability by adding carbon nanoparticles and graphene quantum dots (GQDs) to a silicon-based active material.

Another embodiment of the present disclosure is to provide a negative electrode active material having a high charge capacity by containing a silicon-based active material.

Another embodiment of the present disclosure is to provide a negative electrode active material having an excellent initial cycle charging/discharging capacity while containing a silicon-based active material.

Another embodiment of the present disclosure is to provide a negative electrode active material having excellent rate characteristics while containing a silicon-based active material.

In accordance with an aspect of the disclosure, A negative electrode active material comprises a silicon-based active material; a carbon-based active material; a carbon nanoparticle; and a graphene quantum dot (GQD).

The silicon-based active material is contained in an amount of 5 wt % or more and less than 30 wt % based on 100 wt % of the negative electrode active material.

The GQDs are present in amount of 5 wt % or more and less than 30 wt % based on 100 wt % of the negative electrode active material.

The silicon-based active material contains at least one selected from the group consisting of Si, SiOx (0<x≤2), and Si—C composites.

The silicon-based active material is doped with at least one selected from the group consisting of Li, Mg, Al, Ca, Fe, Ti, and V.

The carbon nanoparticles are prepared in the form of secondary particles by agglomerating a plurality of primary particles having a particle size of 0.1 to 100 nm.

The carbon nanoparticles are contained in an amount of 5 wt % or more and less than 20 wt % based on 100 wt % of the negative electrode active material.

The carbon nanoparticles are formed in a porous structure.

A lithium secondary battery comprises a negative electrode including the negative electrode active material of any one of claims 1 to 8; a positive electrode including a positive electrode active material; and an electrolyte transferring lithium ions to the positive electrode and the negative electrode.

In accordance with another aspect of the disclosure, a method of preparing a negative electrode active material, the method comprises a first preparation step of obtaining a silicon-based active material; and a second preparation step of mixing the silicon-based active material, a GQD, a carbon nanoparticle, and a carbon-based active material with each other.

The first preparation step includes melting and vaporizing a silicon dioxide powder; reducing the vaporized silicon dioxide powder to silicon oxide by injecting a reaction gas; and capturing the reduced silicon oxide as a silicon oxide powder.

the second preparation step includes mixing the silicon-based active material, the GOD, the carbon nanoparticle, and the carbon-based active material with each other; preparing a molded body by heating the mixed materials; and carbonizing and pulverizing the prepared molded body.

### BRIEF DESCRIPTION OF DRAWINGS

The above and other aspects, features, and advantages of the present disclosure will be more clearly understood from the following detailed description taken in conjunction with the accompanying drawings, in which:

FIG. 1 schematically illustrates a negative electrode active material according to an embodiment of the present disclosure.

FIG. 2 is graphs for comparing Raman spectra of negative electrode active materials of Examples 1 to 5 with each other.

FIG. 3 is graphs illustrating XRD pattern results of the negative electrode active materials.

FIG. 4 is Nyquist plots characteristic results of lithium secondary batteries using the negative electrode active materials.

FIG. 5 is graphs illustrating changes in electrical conductivity of the negative electrode active materials depending on contents of silicon oxide.

FIG. 6 illustrates charging/discharging characteristics of lithium secondary batteries manufactured by changing contents of silicon oxide in the negative electrode active materials to 0, 5, 10, 15, and 30 wt %, respectively.

FIG. 7 illustrates rate characteristics obtained by changing current speeds (0.1 C, 0.2 C, 0.5 C, 1 C, and 2 C) of the secondary batteries depending on contents of silicon oxide of the negative electrode active materials.

FIG. 8 is graphs illustrating coulombic efficiency and cycle characteristics depending on contents of silicon oxide in GQD/SiOₓ/C composites.

### DETAILED DESCRIPTION

In the following description, like reference numerals refer to like elements throughout the specification. Well-known functions or constructions are not described in detail since they would obscure the one or more exemplar embodiments with unnecessary detail. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

It will be understood that when an element is referred to as being “connected” another element, it can be directly or indirectly connected to the other element, wherein the indirect connection includes “connection via a wireless communication network”.

Also, when a part “includes” or “comprises” an element, unless there is a particular description contrary thereto, the part may further include other elements, not excluding the other elements.

Throughout the description, when a member is “on” another member, this includes not only when the member is in contact with the other member, but also when there is another member between the two members.

It will be understood that, although the terms first, second, third, etc., may be used herein to describe various elements, but is should not be limited by these terms. These terms are only used to distinguish one element from another element.

As used herein, the singular forms “a,” “an” and “the” are intended to include the plural forms as well, unless the context clearly indicates otherwise.

An identification code is used for the convenience of the description but is not intended to illustrate the order of each step. The each step may be implemented in the order different from the illustrated order unless the context clearly indicates otherwise.

Hereinafter, embodiments of a solid-state electrolyte and a secondary battery including the same according to an aspect will be described in detail with reference to the attached drawings. Configurations described in embodiments of the present specification and illustrated in the accompanying drawings are merely the most preferable embodiments of the present disclosure, and there may be various equivalents and substitutions included in the spirit and scope of the present disclosure at the time of filing this application.

### Negative Electrode Active Material

A negative electrode active material is a compound capable of reversibly intercalating and deintercalating lithium ions.

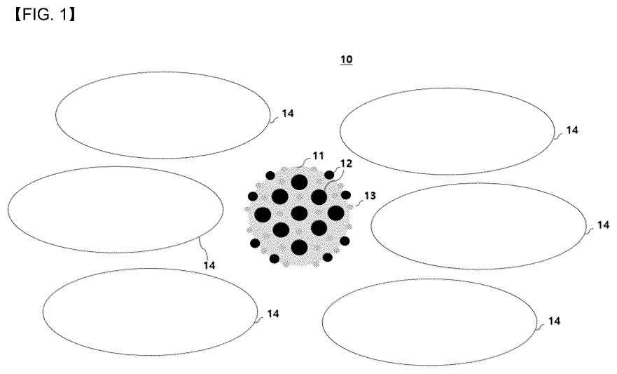

FIG. 1 is a schematic diagram illustrating a silicon-based active material, graphene quantum dots (GQDs), and carbon nanoparticles in a negative electrode active material.

Referring to FIG. 1, a negative electrode active material 10 may contain a silicon-based active material 11 and carbon-based active materials 14, and may further contain carbon nanoparticles 13 and GQDs 12.

The silicon-based active material 11 may be contained in an amount exceeding 5 wt % and less than 30 wt % based on 100 wt % of the negative electrode active material. As a result, the silicon-based active material 11 may provide high-capacity characteristics to the negative electrode active material.

The silicon-based active material 11 may contain at least one selected from the group consisting of Si and SiOₓ (0<x≤2).

According to an embodiment, the silicon-based active material 11 may be SiOₓ (0<x≤2), and preferably SiOₓ (0<x <2). In this case, a volume expansion ratio may be reduced compared to Si, and thus, lifespan characteristics may be improved. In addition, the silicon-based active material 11 may be prepared in a form in which silicon particles are contained in an SiO₂ structure.

The silicon-based active material 11 may be obtained by a known sublimation method of cooling and precipitating a gas of silicon monoxide generated by heating a mixture of silicon dioxide and metal silicon, and may be obtained from the market as silicon oxide, silicon monoxide, silicon monoxide, etc.

The silicon-based active material 11 may be contained in an amount of 5 wt % or more and less than 30 wt % based on 100 wt % of the negative electrode active material. Preferably, the silicon-based active material 11 may be contained in an amount of 7 wt % to 27 wt % based on 100 wt % of the negative electrode active material, and more preferably, may be contained in an amount of 10 wt % to 25 wt % based on 100 wt % of the negative electrode active material.

According to some embodiments, the silicon-based active material 11 may be doped with a dopant to reduce resistance and improve output characteristics. Specifically, the silicon-based active material 11 may be doped with at least one selected from the group consisting of Li, Mg, Al, Ca, Fe, Ti, and V, and the dopant may be contained in an amount of 5 wt % to 25 wt % based on 100 wt % of the silicon-based active material 11. Preferably, the element doped into the silicon-based active material 11 may be Li or Mg.

A particle size of the silicon-based active material 11 may be 20 nm to 450 nm. The silicon-based active material 11 may have a size of about 1 um by agglomerating small particles.

In this case, the silicon-based active material 11 may be prepared in a form in which it is surrounded by carbon nanoparticles 13 and GQDs 12. Accordingly, mechanical stress due to volume expansion of the silicon-based active material 11 during charging and discharging may minimized by the carbon nanoparticles 13 and the GQDs 12 surrounding the silicon-based active material 11, such that structural stability may be improved and electrical conductivity may be improved.

The carbon-based active materials 14 may be natural graphite, artificial graphite, or amorphous carbon, and may be used alone or in combination with two or more.

The carbon-based active materials 14 may be contained in a weight ratio of 20 to 90 wt % based on 100 wt % of the negative electrode active material, and preferably, may be 50 to 75 wt % based on 100 wt % of the negative electrode active material. In this case, the weight ratio of the carbon-based active materials may be determined depending on the weight ratio of the silicon-based active material 11, GQDs 12, and carbon nanoparticles 13. For example, if the silicon-based active material 11 and GQDs 12 are contained in a relatively large amount in the negative electrode active material, the carbon-based active materials may be contained in a smaller amount accordingly.

The carbon nanoparticles 13 may be prepared in the form of secondary particles by agglomerating a plurality of primary particles having a particle size of 0.1 to 100 nm and formed in a porous structure. The carbon nanoparticles 13 are distributed in the form in which they surround the silicon-based active material 11 and have an effect of mitigating the volume expansion of the silicon-based active material 11 and improving the electrical conductivity of the silicon-based active material 11.

The carbon nanoparticles 13 are uniformly distributed in the negative electrode active material, form an internal cavity in the negative electrode active material, and may serve to mitigate the volume expansion of the silicon-based active material 11 by adding carbon nanoparticles 13.

The carbon nanoparticles 13 contain 96 to 98% of carbon formed as fine particles in the form of colloids, and are formed as a surface with a large surface area and high conductivity to form a porous structure. In other words, the carbon nanoparticles 13 have a large specific surface area and high electrical conductivity. Accordingly, the carbon nanoparticles 13 may form a porous structure in the negative electrode active material to provide structural stability that buffers the volume expansion of the silicon-based active material 11 and improve electrical conductivity.

The carbon nanoparticles 13 may be, for example, carbon black or acetylene black, and may be used alone or in combination with two or more.

The carbon nanoparticles 13 may be contained in a weight ratio of 1 wt % to 20 wt % based on 100 wt % of the negative electrode active material.

The graphene quantum dots (GQDs) 12 serve to improve conductivity in the negative electrode active material. The GQDs 12 have the effect of improving the electrical conductivity of the silicon-based active material 11 together with the carbon nanoparticles 13.

The GQDs 12 may be located within the silicon-based active material 11 and may serve to protect defects within the silicon-based active material 11, thereby buffering mechanical stress caused by a volume change in the silicon-based active material 11.

The GQDs 12 may be contained in an amount of 5 wt % or more and less than 30 wt % based on 100 wt % of the negative electrode active material. In this case, the GQDs 12 may be contained in the negative electrode active material a weight ratio equal to or similar to the content of the silicon-based active material 11.

The GQDs 12 may be prepared by adding a redox reaction process to the oxide graphene structure, and may be prepared to have a particle size of 5 nm to 50 nm. That is, as illustrated FIG. 1, the particle size of the GQDs 12 may be various.

### Negative Electrode

The negative electrode has a current collector and a negative electrode material layer provided on the current collector and including a negative electrode active material, a binder, etc. For example, the negative electrode of the present disclosure may be obtained by preparing a coating solution mixed with a negative electrode active material, a binder, a thickener, and a solvent such as a solvent or water, etc., applying (coating) this coating solution to a current collector, drying the solvent or water, and performing pressure molding to form a negative electrode material layer. The current collector may be made of, for example, copper.

The binder is not particularly limited, but may include, for example, a styrene-butadiene copolymer; a (meth)acrylic copolymer obtained by copolymerizing an ethylenically unsaturated carboxylic acid ester such as methyl (meth)acrylate, ethyl (meth)acrylate, butyl (meth)acrylate, (meth)acrylonitrile, and hydroxyethyl (meth)acrylate with an ethylenically unsaturated carboxylic acid such as acrylic acid, methacrylic acid, itaconic acid, fumaric acid, and maleic acid; and a polymer compound such as polyvinylidene fluoride, polyethylene oxide, polyepichlorohydrin, polyphosphazene, polyacrylonitrile, polyimide, and polyamideimide.

The binder may be contained in an amount of 0.1 wt % to 20 wt % in the negative electrode material layer.

If the content of binder is 0.1 wt % or more, the adhesion is good, and the negative electrode tends to be suppressed from being destroyed by expansion and contraction during charging and discharging. On the other hand, if the content of binder is 20 wt % or less, the electrode resistance tends to be suppressed from increasing.

### Lithium Secondary Battery

A lithium secondary battery of the present disclosure includes a positive electrode, the negative electrode, and an electrolyte.

A lithium-ion secondary battery may be constituted by disposing a negative electrode so as to face a positive electrode through, for example, a separator and injecting an electrolyte solution containing an electrolyte.

The positive electrode may be obtained by forming a positive electrode material layer on a surface of a current collector in the same manner as the negative electrode. A positive electrode current collector may be made of, for example, aluminum.

The positive electrode active material of the positive electrode material layer of the lithium secondary battery of the present disclosure is a compound capable of reversibly intercalating and deintercalating lithium ions. Specifically, the positive electrode active material may contain one or more metals such as cobalt, manganese, nickel, or aluminum, and a lithium metal oxide containing lithium. For example, the lithium metal oxide may include a lithium-manganese-based oxide, a lithium-cobalt-based oxide, a lithium-nickel-based oxide, a lithium-cobalt-nickel-based oxide, a lithium-nickel-manganese-cobalt-based oxide, or a lithium iron phosphate.

The electrolyte is not particularly limited, and a known one may be used. For example, a non-aqueous lithium-ion secondary battery may be manufactured by using a solution obtained by dissolving an electrolyte is dissolved in an organic solvent as a liquid electrolyte. Examples of the electrolyte include LiPF₆, LiClO₄, LiBF₄, LiClF₄, LiAsF₆, LiSbF₆, LiAlO₄, LiAlCl₄, LiN(CF₃SO₂)₂, LiN(C₂F₅SO₂) ₂, LiC(CF₃SO₂)₃, LiCl, and LiI. As an organic solvent, any solvent capable of dissolving the electrolyte may be used, and examples thereof include propylene carbonate, ethylene carbonate, diethyl carbonate, ethyl methyl carbonate, vinyl carbonate, y-butyrolactone, 1,2-dimethoxyethane, and 2-methyltetrahydrofuran.

On the other hand, the electrolyte is not limited to a liquid electrolyte, and a solid electrolyte may also be used.

Various known separators may be used as separators. Specifically, paper separators, polypropylene separators, polyethylene separators, glass fiber separators, and the like may be mentioned.

However, when the solid electrolyte is used, the separator may not be included in the lithium secondary battery.

### Examples

### Preparation of Negative Electrode Active Material

To prepare a negative electrode active material, GQDs and carbon nanoparticles were synthesized, and silicon oxide (SiOₓ) to which magnesium is added was used as a filler of a molded body.

A mixing ratio of the GQDs, the carbon nanoparticles, and a silicon-based active material was shown in Table 1.

The GQDs having a particle size of 5 to 50 nm may be prepared by adding a redox reaction process to a graphene oxide structure.

The carbon nanoparticles may be prepared by heat-treating graphite under a CO gas atmosphere at 900° C. for 4 hours. Accordingly, the carbon nanoparticles may be prepared in the form of secondary particles having a particle size 5 to 50 nm by agglomerating primary particles having a particle size of 5 to 10 nm.

SiOₓ may be prepared by a heat treatment process. SiOₓ may be doped with 5 to 20 wt % of Mg by a heat treatment process at 600 to 950° C. for 0.5 to 2 hours.

The SiOₓ nanoparticles were synthesized through a volatilization and condensation process in an induction melting heater. A material was put in a crucible, a certain current was applied to a structure surrounding the crucible to melt Si, and then, a mixture of O₂ and Ar gas was injected to evaporate SiOₓ. After a synthesis time of 30 to 60 minutes, the applied current was reduced to cool synthesized SiOₓ nanoparticles and condense the synthesized SiOₓ nanoparticles in a chamber to obtain SiOₓ.

A method of preparing a negative electrode active material may include a first preparation step of obtaining a silicon-based active material and a second preparation step of mixing the silicon-based active material, GQDs, carbon nanoparticles, and carbon-based active materials with each other.

The first preparation step includes: melting and vaporizing a silicon dioxide powder, reducing the vaporized silicon dioxide powder to silicon oxide by injecting a reaction gas, and capturing the reduced silicon oxide as a silicon oxide powder.

The second preparation step may include: mixing the silicon-based active material, the GOD, the carbon nanoparticle, and the carbon-based active material with each other, preparing a molded body by heating the mixed materials, and carbonizing and pulverizing the prepared molded body.

Specifically, a method of preparing the silicon oxide powder in the first preparation step will be described. A nano-sized silicon oxide powder may be prepared by: 1) melting and vaporizing a material including a mixed powder of silicon and silicon dioxide, or a silicon dioxide powder using an induction melting heater or a thermal plasma device (it is performed under an argon atmosphere at a flow rate of 5 to 20 L/min as a purge gas in a crucible made of tungsten in the case of using 5 to 20 L/min of argon and 1 to 5 L/min of nitrogen as generating gases and using a material including a mixture powder of silicon and silicon dioxide mixed in a molar ratio of 2:1), 2) reducing the silicon dioxide in the vaporized gas to silicon oxide (SiOₓ) (0.2<x<1.3) by injecting a reaction gas (hydrogen) into the induction melting heater or the thermal plasma device at 0.1 to 2.0 L/min (SiOₓ), and 3) capturing the reduced silicon oxide as a silicon oxide (SiOₓ) powder.

The SiOₓ, the GOD, and the carbon nanoparticle prepared by the method described above were mixed with each other according to a mixing ratio in Table 1, and were shown in Examples 1 to 5. In Examples 1 to 5, a weight ratio of SiOₓ and GQD was changed to 0, 5, 10, 15, and 30 wt %, respectively, and wt % of graphite was adjusted accordingly.

Specifically, the second preparing step will be described. A molded body was prepared using a Thinky mixer (2500 rpm, 90 minutes) to uniformly mix and disperse the materials and using a heated press (190° C., 20 minutes) to improve a density of a mixed material. The prepared molded body was positioned at the center of a furnace and carbonized under an argon atmosphere at 600° C. for 5 hours at a rate of 5° C./min. The carbonized molded body was pulverized and sonicated in a tetrahydrofuran (THF) solvent for 20 minutes. Then, the dispersed solution was stirred using a thermal stirrer (300 rpm, 8 hours) and dried at 80° C. to prepare a composite. The prepared composite was carbonized under an argon atmosphere at 600° C. for 6 hours at a rate of 5° C./min. The prepared composite was pulverized and impurities were removed to prepare a particle size of 10 μm or less. The prepared negative electrode active material was classified into GQD/SiOₓ/carbon nanoparticles depending on the content of silicon oxide.

TABLE 1

| | | | | | | | Carbon | Carbon |
|---|---|---|---|---|---|---|---|---|
| | SiOₓ | SiOₓ | Graphite | Graphite | GQD | GQD | nanoparticles | nanoparticles |
| | (wt %) | (g) | (wt %) | (g) | (wt %) | (g) | (wt %) | (g) |
| Example | 0 | 0 | 83 | 8.79 | 0 | 0 | 17% | 1.8 |
| 1 | | | | | | | | |
| Example | 5 | 0.54 | 73 | 7.88 | 5 | 0.51 | 17% | 1.8 |
| 2 | | | | | | | | |
| Example | 10 | 1.1 | 63 | 6.93 | 10 | 1.12 | 17% | 1.8 |
| 3 | | | | | | | | |
| Example | 15 | 1.52 | 53 | 5.37 | 15 | 1.51 | 17% | 1.8 |
| 4 | | | | | | | | |
| Example | 30 | 3.04 | 23 | 2.33 | 30 | 3.02 | 17% | 1.8 |
| 5 | | | | | | | | |

### Manufacture of Electrode (Half-Cell)

An electrode was manufactured to analyze electrochemical characteristics of a GQD/SiOₓ/C composite depending on a content of silicon oxide. In the electrode, a negative electrode active material and an aqueous binder (CMC, SBR) were mixed with each other in a weight ratio of 8.5:1.5 in a Thinky mixer (2,500 rpm, 2 minutes). The mixed slurry was coated onto a copper foil to manufacture a current collector electrode, and the electrode was dried in a vacuum oven at 120° C. for 8 hours. An electrode density of the coated electrode was improved through a rolling process using a roll press, and a half cell was manufactured using lithium metal as the electrode in a glove box. The cycle, rate characteristics, and impedance analysis of the manufactured half-cell were evaluated using a wbcs 3000 battery cycler (Won A Tech, Inc.).

### Evaluation of Physical Property

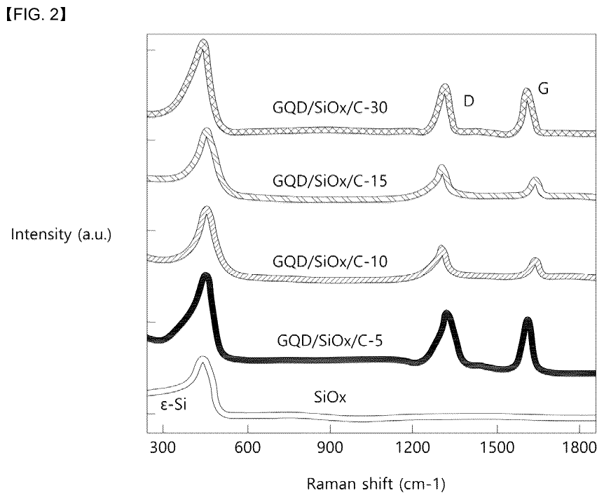

FIG. 2 is graphs for comparing Raman spectra of negative electrode active materials of Examples 1 to 5 with each other.

Referring to FIG. 2, it can be seen that in the case of SiOₓ, a band in a range of 400 to 500 cm⁻¹ was assigned to amorphous SiO, and a Si peak appeared in a Raman spectrum of a GQD/SiOₓ/C composite. There is no distinct change in an amorphous SiO peak in the Raman spectrum depending on a content (0 to 30 wt %) of GQDs in the GQD/SiOₓ/C composite, but in the case of 1,348 cm⁻¹ (D-band), the smallest defect peak intensity can be observed in GQD/SiOₓ/C-15 (a content of GQDs is 15 wt %). In addition, it can be seen that the GQD/SiOₓ/C-10 (a content of GQDs is 10 wt %) composite showed a characteristic of a small peak intensity at 1,348 cm⁻¹ (D-band). Therefore, it can be seen that an optimal content of GQDs was 15 wt %, and an optimal range for improving structural stability of the GQD/SiOₓ/C composite was that the content of GQDs is 10 to 15 wt %.

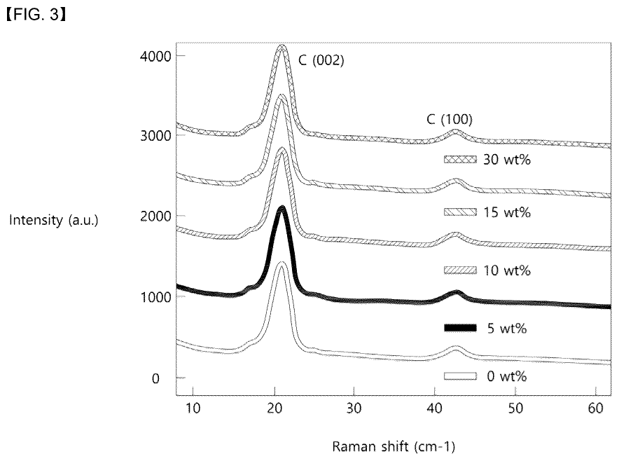

FIG. 3 is graphs illustrating XRD pattern results of the negative electrode active materials.

Referring to FIG. 3, the carbon particles showed broad amorphous peaks at 26° and 44°, and each peak showed crystal planes of C (002) and C (100). Silicon oxide showed broad and low peaks at 28.35°, 47.24°, and 56.23°, which are characteristics of an amorphous structure. This is because the amorphous SiO₂ structure was formed in silicon oxide, and the Si main lattice of Si (111), Si (220), and Si (311) were observed. Regardless of the content, for GQD/SiOₓ/C composites, peaks at 25.9° and 55.27° were observed, which showed the crystal structures of C (002) and C (004), which are the crystal structures of carbon. The negative electrode active material is assumed to be obtained by crystallizing a carbon structure in a carbonization process by a pitch because a composite is formed through the pitch. The carbon nanoparticles were prepared in a heat treatment process through the pitch, and XRD peaks appear in the carbon nanoparticles are structural characteristics of the carbon nanoparticles. In addition, it can be determined that since peaks other than the carbon peak were not observed, a structure change to a SiC form due a reaction between the silicon oxide and the pitch in a thermal treatment process did not occur. As a result of XRD analysis, it was confirmed that the carbon intensity relatively was reduced as a content of silicon oxide was increased in the order of 0, 10, and 30 wt %. This is because the carbon content was relatively reduced as the content of silicon oxide in the composite was increased.

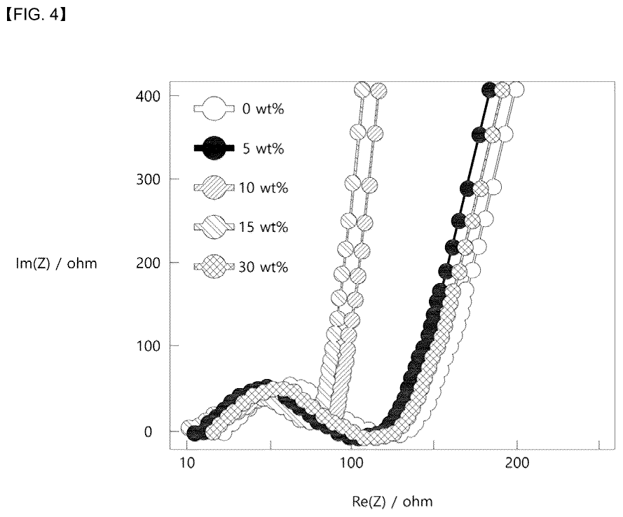

FIG. 4 is Nyquist plots characteristic results of lithium secondary batteries using the negative electrode active materials.

Referring to FIG. 4, in a high-frequency region, ohmic resistance due to external connection, contact resistance, and ion conduction in the electrolyte may be observed. In a low-frequency region, the resistance due to the movement of electric charges may be observed. It was confirmed that the resistance was reduced in the order of 30, 15, and 10 wt % in the composite with a high content. In the negative electrode active material, resistance values ware reduced through a reduction in sizes of semicircles in the order of 15, 10, and 0 wt %. This is opposite to the electrical conductivity of the composite in the results of FIG. 3 as the content of silicon oxide increases. Thus, it can be seen that there is a difference between the electrical conductivity of the composite and the electronic resistance as a negative electrode material. Within the composite, a cavity is formed with a high surface area of the GQDs and carbon nanoparticles, and when the content of silicon oxide is increased, the electrical conductivity is improved as an internal cavity of the composite is reduced. However, when the content of silicon oxide is increased during charging and discharging, the stability of the electrode was reduced due to the volume expansion of silicon oxide, resulting in increased resistance and reduced electrical conductivity. In addition, when the degree of ion diffusion in the GQD/SiOₓ/C composites was compared depending on the content of silicon oxide, it could be seen that a slope of a straight lines of the composites 0 and 15 wt % was high, which was advantageous for the diffusion of lithium ions. However, when the content of silicon oxide in the GQD/SiOₓ/C composite was 30 wt %, a low linear slope was observed, which is determined to be due to low ionic conductivity of the GQD/SiOₓ/C-20 composite. Low ionic conductivity was usually observed in silicon-based negative electrode materials, and thus, in the GQD/SiOₓ/C-20 composite, the internal cavity of the composite may not accommodate a change in volume of the silicon oxide during charging and discharging, resulting in poor structural stability of the composite. Based on these results, an appropriate ratio of the content of silicon oxide in the GQD/SiOₓ/C composite is determined to be 15 wt %.

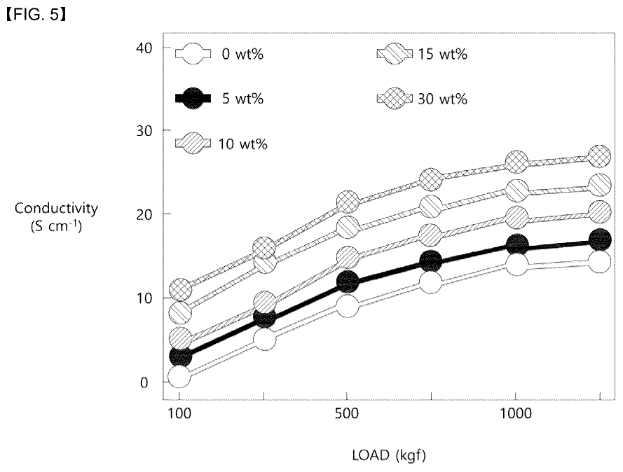

FIG. 5 is graphs illustrating changes in electrical conductivity of the negative electrode active materials depending on the content of silicon oxide.

Referring to FIG. 5, the carbon nanoparticles used had a high electrical conductivity of 26 S/cm, while the silicon oxide was an insulator and had an electrical conductivity close to 0 S/cm. The carbon material showed an electrical conductivity of 1.9 S/cm, and an electrical conductivity of the GQD/SiOₓ/C-0 composite was increased by about 8.3 times by the addition of carbon nanoparticles with high electrical conductivity. When the silicon oxide was added to the GQD/SiOₓ/C composite, the electrical conductivity was improved by about 1.9 times, which is determined to be due to a decrease in the volume of the cavity in a composite structure and an increase in a composite density.

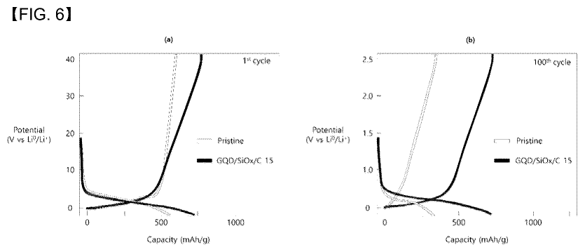

FIG. 6 illustrates charging/discharging characteristics of lithium secondary batteries manufactured by changing contents of silicon oxide in the negative electrode active materials to 0, 5, 10, 15, and 30 wt %, respectively.

Referring to FIG. 6, initial charging/discharging results were obtained by performing an experiment between 0.01 V and 4 V depending on the content of a silicon composite. The composite to which SiOₓ is added showed a flat curve at 0.1 V, which is determined to be due to a reaction occurring between lithium ions and silicon in the composite. In addition, as a result of the initial charging/discharging measurement, it can be confirmed that an initial charge capacity was improved as the content of SiOₓ in the composite was increased. This is because the content of SiOₓ with high capacity was increased. Table 2 below showed the charging/discharging capacities of an initial cycle at 0.1 C according to Examples 1 to 5.

TABLE 2

| | 1^{st} charge capacity | 1^{st} charge capacity | Initial |
|---|---|---|---|
| | (mAh/g) | (mAh/g) | efficient (%) |
| Example 1 | 594 | 425 | 71.6 |
| Example 2 | 615 | 445 | 72.4 |
| Example 3 | 634 | 493 | 77.9 |
| Example 4 | 768 | 595 | 77.5 |
| Example 5 | 867 | 591 | 68.2 |

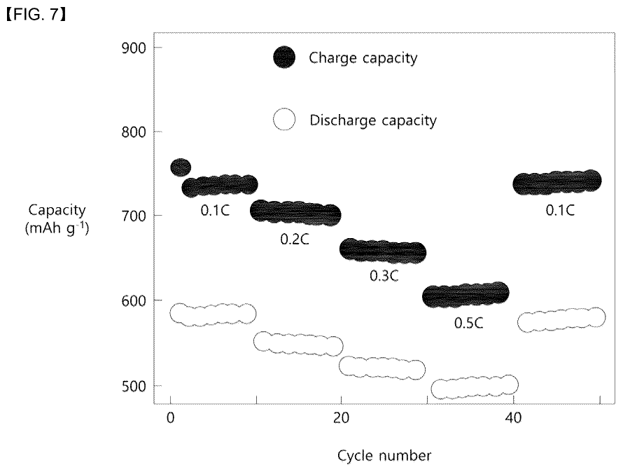

FIG. 7 illustrates rate characteristics obtained by changing current speeds (0.1 C, 0.2 C, 0.5 C, 1 C, and 2 C) of the secondary batteries depending on the content of silicon oxide of the negative electrode active materials.

Referring to FIG. 7, it can be confirmed that as the content of silicon oxide was increased from 0 to 15 w %, the rate characteristics were improved from 76 to 81. It can be seen that similar to the result of the electrical conductivity analysis in FIG. 3, as silicon oxide was added to the composite, electrical conductivity of the composite was increased, such that rate characteristics were improved. It can be seen that a path through which lithium ions may move was provided to a silicon oxide having low electrical conductivity through high electrical conductivity and high specific surface area of GQDs and carbon nanoparticles, resulting in improved rate characteristics.

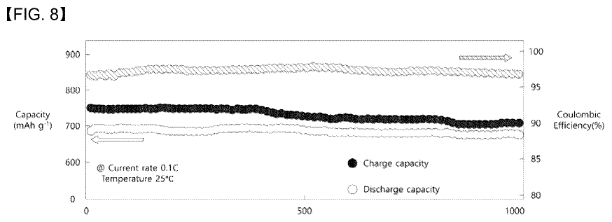

FIG. 8 is graphs illustrating coulombic efficiency and cycle characteristics depending on the contents of silicon oxide in GQD/SiOₓ/C composites.

Referring to FIG. 8, high Coulombic efficiency is important for applying a silicon-based active material. Generally, since graphite has a high coulombic efficiency of 91-95%, graphite is used in combination with a carbon-based material. The GQD/SiOₓ/C-0 composite had a low first coulombic efficiency due to its irreversible capacity, but showed a high coulombic efficiency of 94% or more in the 2^{nd} cycle. It is determined that this is because the volume expansion of silicon oxide occurs due to the SEI layer on the electrode surface and the insertion and deintercalation of lithium ions, but the internal cavity of the composite by the GQDs and carbon nanoparticles buffers the volume change of silicon oxide, thereby achieving stable cycle performance.

As the content of silicon oxide in the GQD/SiOₓ/C composite was increased from 0 to 15 wt %, the charge capacity was improved from 594 mAh/g to 867 mAh/g. The GQD/SiOₓ/C composite showed higher capacity characteristics than the existing graphite negative electrode materials. It is determined that the capacity was improved by providing a storage path for lithium ions in the internal cavity by the GQDs and carbon nanoparticles. When the content of silicon oxide was less than 10 wt %, the effect of capacity improvement was minimal, but the initial efficiency was higher than that of GQD/SiOₓ/C-0. It is determined that this is due to the formation of an excessive SEI layer in the cavity formed by the high surface area of the GQDs and carbon nanoparticles, resulting in increased irreversible capacity. Therefore, the addition of silicon oxide reduces the cavity volume due to sharing of empty spaces within the composite, thus reducing the specific surface. A reaction area between the reduced specific surface and lithium ions becomes small and thus, an irreversible capacity is reduced. When the irreversible capacity is reduced, a difference between initial charging and discharging capacities is reduced, such that initial efficiency is improved. As a result, the discharge capacity tended to increase from 425 mAh/g to 595 mAh/g as the content of silicon oxide in the GQD/SiOₓ/C composite was increased from 0 to 15 wt %, and the initial efficiency was improved from 75% to 83%. During charging and discharging, in the silicon-based composite, a large volume change was caused by the repeated intercalation and deintercalation of lithium ions, and the structure of the composite was broken to form an excessive SEI layer, thereby decreasing initial efficiency and cycle stability. To solve this problem, GQDs and carbon nanoparticles with a large surface area providing the cavity within the composite were introduced, and a volume change of silicon oxide was mitigated to maintain a structure, resulting in cycling stability. However, when the content of silicon oxide is lower than those of GQDs and carbon nanoparticles, the initial efficiency was low due to the cavities caused by the high surface area of the GQDs and carbon nanoparticles. Therefore, it was confirmed that the initial efficiency could be improved when the silicon oxide content was 10 wt % or more compared to the GQDs and carbon nanoparticles in the GQD/SiOₓ/C composite. In addition, silicon formed an SEI layer through an alloying reaction with lithium ions, and irreversible capacity occurred, thereby decreasing the initial efficiency.

The negative electrode active material according to an embodiment of the present disclosure has an effect of improving electrical conductivity and structural stability by adding carbon nanoparticles and GQDs to the silicon-based active material.

The negative electrode active material according to an embodiment of the present disclosure has a high charge capacity by containing a silicon-based active material.

The negative electrode active material according to an embodiment of the present disclosure has an effect of an excellent initial cycle charge/discharge capacity while containing a silicon-based active material.

The negative electrode active material according to an embodiment of the present disclosure has an effect of excellent rate characteristics while containing a silicon-based active material.

The disclosed embodiments have been described hereinabove with reference to the accompanying drawings. It will be understood by those skilled in the art to which the present disclosure pertains that the present disclosure may be practiced in forms different from those of the disclosed embodiments without changing the technical spirit or essential characteristics of the present disclosure. The disclosed embodiments are illustrative, and should not be construed as being restrictive.

### Descriptions of Symbols

10: Negative electrode active material
11: Silicon-based active material
12: Graphene quantum dot (GQD)
13: Carbon nanoparticle
14: Carbon-based active material

What is claimed is:

1. A negative electrode active material comprising:
a silicon-based active material;
a carbon-based active material;
a carbon nanoparticle; and
a graphene quantum dot (GQD).

2. The negative electrode active material of claim 1, wherein the silicon-based active material is contained in an amount of 5 wt % or more and less than 30 wt % based on 100 wt % of the negative electrode active material.

3. The negative electrode active material of claim 1, wherein the GQDs are present in amount of 5 wt % or more and less than 30 wt % based on 100 wt % of the negative electrode active material.

4. The negative electrode active material of claim 1, wherein the silicon-based active material contains at least one selected from the group consisting of Si, SiOₓ (0<x≤2), and Si—C composites.

5. The negative electrode active material of claim 1, wherein the silicon-based active material is doped with at least one selected from the group consisting of Li, Mg, Al, Ca, Fe, Ti, and V.

6. The negative electrode active material of claim 1, wherein the carbon nanoparticles are prepared in the form of secondary particles by agglomerating a plurality of primary particles having a particle size of 0.1 to 100 nm.

7. The negative electrode active material of claim 1, wherein the carbon nanoparticles are contained in an amount of 5 wt % or more and less than 20 wt % based on 100 wt % of the negative electrode active material.

8. The negative electrode active material of claim 1, wherein the carbon nanoparticles are formed in a porous structure.

9. A lithium secondary battery comprising:
a negative electrode including the negative electrode active material of claim 1;
a positive electrode including a positive electrode active material; and
an electrolyte transferring lithium ions to the positive electrode and the negative electrode.

10. A method of preparing a negative electrode active material, the method comprising:
a first preparation step of obtaining a silicon-based active material; and
a second preparation step of mixing the silicon-based active material, a GQD, a carbon nanoparticle, and a carbon-based active material with each other.

11. The method of claim 10, wherein the first preparation step includes:
melting and vaporizing a silicon dioxide powder;
reducing the vaporized silicon dioxide powder to silicon oxide by injecting a reaction gas; and
capturing the reduced silicon oxide as a silicon oxide powder.

12. The method of claim 11, wherein the second preparation step includes:
mixing the silicon-based active material, the GQD, the carbon nanoparticle, and the carbon-based active material with each other;
preparing a molded body by heating the mixed materials; and
carbonizing and pulverizing the prepared molded body.
